(19) United States
(12) Patent Application Publication
(10) Pub. No.: US 2008/0078093 A1
(43) Pub. Date: Apr. 3, 2008

(54) Connecting structure for T-square

(75) Inventor: Wen-Yuan Lin, Taipei County (TW)

Correspondence Address: WEN-YUAN LIN, 20525 Via Talavera, Yorba Linda, CA, 92887, US

(73) Assignee: YOUTH TOY ENTERPRISE CO., LTD.

(21) Appl. No.: 11/541,612

(22) Filed: Oct. 3, 2006

(51) Int. Cl. B43L 7/00

(52) U.S. Cl. 33/478

(57) ABSTRACT

A connecting structure for T-square including a raised connecting section provided at an upper middle position of a crosspiece of the T-square, and a recessed fixing section correspondingly provided at a lower front end of a straight rule of the T-square for detachably receiving the raised connecting section therein. Therefore, the crosspiece and the straight rule of the T-square may be easily assembled to and disassembled from each other. And, the disassembled T-square may be conveniently carried or stored.

### FIELD OF THE INVENTION

The present invention relates to a connecting structure for T-square, and more particularly to a connecting structure that enables a crosspiece and a straight rule of a T-square to be easily assembled to or disassembled from each other.

### BACKGROUND OF THE INVENTION

FIGS. 1 and 2 are assembled and exploded perspective views, respectively, showing two typical manners for connecting a crosspiece 30 and a straight rule 31 of a T-square. In FIG. 1, the crosspiece 30 and the straight rule 31 are spliced and screwed together using a plurality of wood screws 32. In FIG. 2, the straight rule 31 is provided on a rigid wall at a lower front end with a tenon 33 having specific shape and angular edges, and the crosspiece 30 is provided on an upper middle position with a mortise 34 for fitly receiving the tenon 33 therein, so as to tightly connect the crosspiece 30 to the straight rule 31.

As can be find by one of ordinary skill in the art, the above connecting manners for T-square have the following drawbacks:
1. In the connecting manner as illustrated in FIG. 1, the crosspiece 30 is fixedly screwed to the straight rule 31 with wood screws, making the T-square not convenient for carrying or storage.
2. In the connecting manner as illustrated in FIG. 2, when the mortise 34 has inaccurate dimensions larger than that of the tenon 33, or when the mortise 34 is worn and becomes widened after having been used over a long period of time, the straight rule 31 tends to loosen from the crosspiece 30.

It is therefore tried by the inventor to develop an improved connecting structure for easily and tightly assembling the crosspiece to the straight rule of a T-square while allowing convenient disassembling of the crosspiece from the straight rule when necessary.

### SUMMARY OF THE INVENTION

A primary object of the present invention is to provide a connecting structure for T-square, so that a crosspiece and a straight rule of the T-square may be easily disassembled for convenient carrying or storage.

To achieve the above and other objects, the connecting structure for T-square according to the present invention includes a raised connecting section provided at an upper middle position of a crosspiece of the T-square, and a recessed fixing section correspondingly provided at a lower front end of a straight rule of the T-square for firmly receiving the raised connecting section therein. Therefore, the crosspiece and the straight rule of the T-square may be easily assembled to and disassembled from each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a T-square having crosspiece and straight rule connected together via wood screws;

FIG. 2 is an exploded view of a T-square having crosspiece and straight rule connected together via tenon and mortise;

FIG. 3 is an exploded perspective view showing a connecting structure for T-square according to a first embodiment of the present invention;

FIG. 4 is a fragmentary bottom view showing the crosspiece and straight rule of a T-square before being connected to each other via the connecting structure of FIG. 3; FIG. 5 is a sectional view taken along line A-A of FIG. 4;

FIG. 6 is a fragmentary bottom view showing the crosspiece and straight rule of the T-square of FIG. 4 have been fully connected to each other via the connecting structure of FIG. 3;

FIG. 7 is a sectional view taken along line B-B of FIG. 6; and

FIG. 8 is an exploded bottom view showing a connecting structure for T-square according to a second embodiment of the present invention.

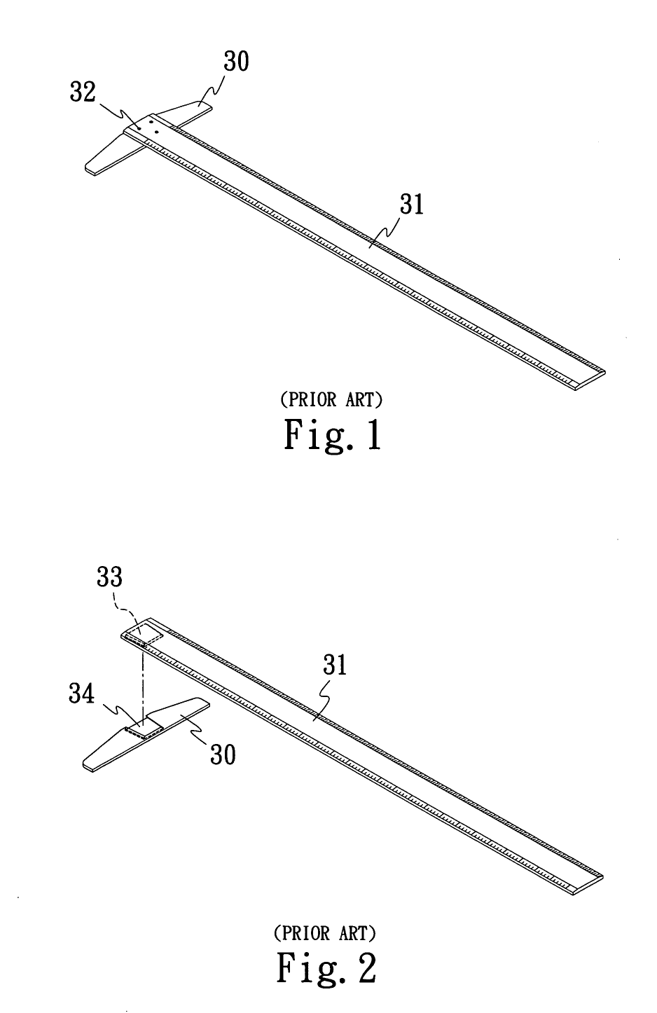

### DETAILED DESCRIPTION OF THE PREFERRED EMBODIMENTS

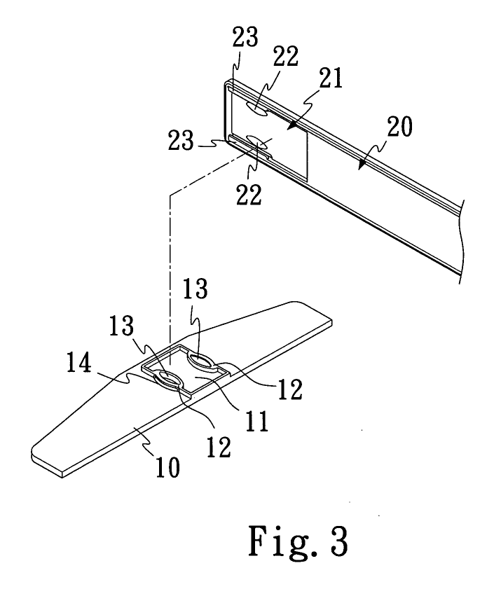

Please refer to FIG. 3 that is an exploded perspective view of a connecting structure for T-square according to a first embodiment of the present invention. As shown, the T-square includes a crosspiece 10 and a straight rule 20. The crosspiece 10 is provided at an upper middle position on a rigid wall thereof with a raised connecting section 11, which includes a pair of symmetric retaining elements 12 and a pair of ribs 14. Each of the retaining elements 12 defines an inner opening 13, and the two ribs 14 are symmetrically formed at two lateral outer sides of the raised connecting section 11. The straight rule 20 is provided at a lower front end with a recessed fixing section 21. When the crosspiece 10 is assembled to the straight rule 20, the raised connecting section 11 is received in the recessed fixing section 21. More specifically, two rails 23 are symmetrically formed in the recessed fixing section 21 at two lateral walls thereof corresponding to the two ribs 14 at the raised connecting section 11, so as to prevent the crosspiece 10 from separating from the straight rule 20 once the raised connecting section 11 has been received in the recessed fixing section 21; and two stops 22 are symmetrically provided in the recessed fixing section 21 near two opposite lateral sides adapted to engage with the two openings 13 defined by the retaining elements 12, so as to enable enhanced connection of the crosspiece 10 to the straight rule 20.

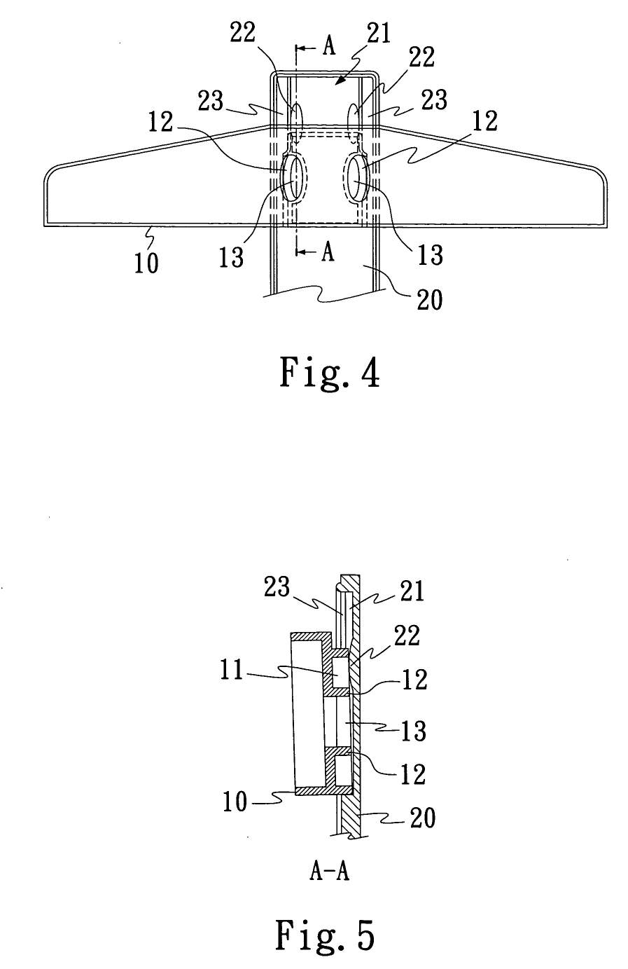

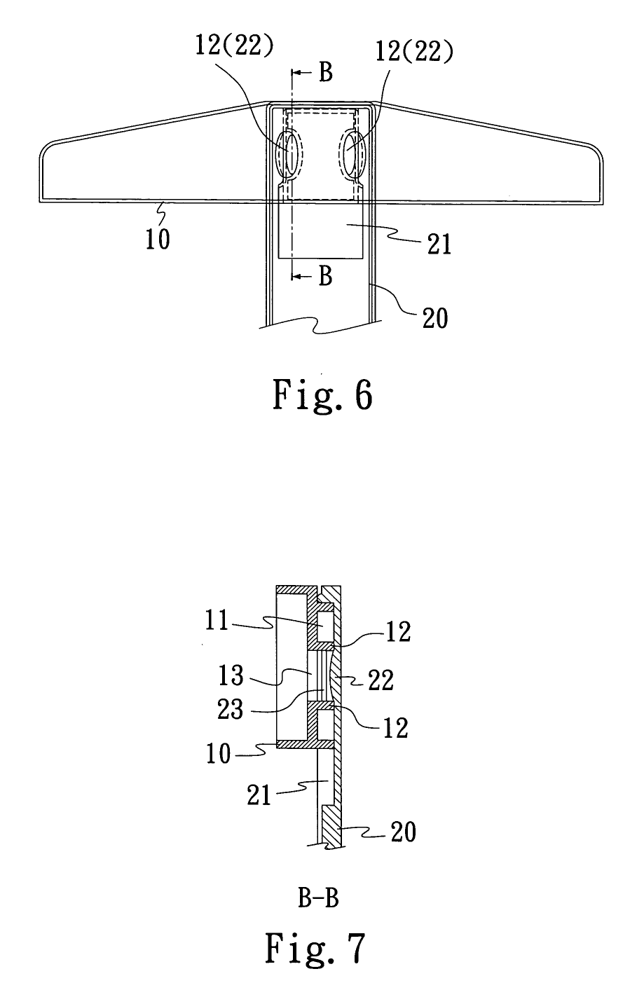

Please refer to FIG. 4 that is a bottom view showing the manner of assembling the crosspiece 10 to the straight rule 20, and to FIG. 5 that is a sectional view taken along line A-A of FIG. 4. When it is desired to assemble the crosspiece 10 to the straight rule 20, align the raised connecting section 11 with the recessed fixing section 21; slide the crosspiece 10 toward the lower front end of the straight rule 20, until the openings 13 of the raised connecting section 11 are engaged with the stops 22 in the recessed fixing section 21, as shown in FIGS. 6 and 7. At this point, the crosspiece 10 is fully assembled to the straight rule 20.

When it is desired to disassemble the crosspiece 10 from the straight rule 20, simply slide the crosspiece 10 toward a rear end of the straight rule 20 until the raised connecting section 11 is moved out of the recessed fixing section 21. The T-square with disassembled crosspiece 10 and straight rule 20 can be very conveniently carried or stored.

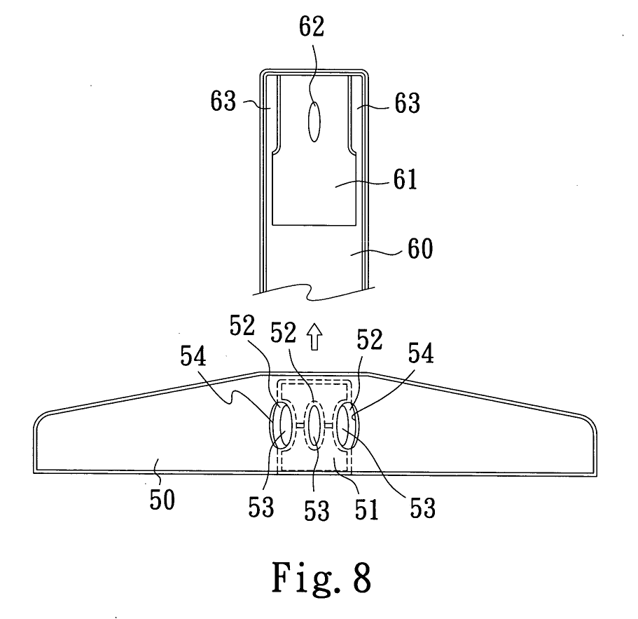

FIG. 8 is an exploded bottom view showing a connecting structure for T-square according to a second embodiment of the present invention. In the second embodiment, the T-square includes a crosspiece 50 and a straight rule 60. The crosspiece 50 is provided at an upper middle position with a raised connecting section 51, in which a plurality of retaining elements 52 are separately provided at predetermined positions. Each of the retaining elements 52 defines an inner opening 53. Two ribs 54 are symmetrically provided at two lateral outer sides of the raised connecting section 51. The straight rule 60 is provided at a lower front end with a recessed fixing section 61. In an operable embodiment of the present invention, a stop 62 is provided in the recessed fixing section 61 at a middle position corresponding to the two ribs 54, so as to engage with one of the openings 53 of the retaining elements 52 to enhance the connection of the crosspiece 50 to the straight rule 60; and two rails 63 are symmetrically formed in the recessed fixing section 61 to engage with the ribs 54. Therefore, the crosspiece 50 is prevented from easily separating from the straight rule 60 once the raised connecting section 51 has been received in the recessed fixing section 61.

With the above arrangements, the connecting structure for T-square according to the present invention enables the crosspiece and straight rule of a T-square to be easily assembled to and disassembled from each other for convenient carrying or storage.

The present invention has been described with some preferred embodiments thereof, and it is understood these embodiments are not intended to limit the scope of the present invention. For example, the raised connecting sections 11, 51 may be provided at the lower front end of the straight rules 20, 60, while the recessed fixing sections 21, 61 are provided at the upper middle position of the crosspieces 10, 50. Many other changes and modifications in the described embodiments can still be carried out without departing from the scope and the spirit of the invention that is intended to be limited only by the appended claims.

What is claimed is:

1. A connecting structure for T-square, said T-square including a straight rule and a crosspiece, and said connecting structure comprising a raised connecting section provided at an upper middle position of said crosspiece, and a recessed fixing section provided at a lower front end of said straight rule adapted to receive said raised connecting section therein, such that said straight rule is connected at said lower front end to the upper middle position of said crosspiece.

2. The connecting structure for T-square as claimed in claim 1, wherein said raised connecting section includes a pair of symmetric retaining elements, and two ribs formed at two lateral outer sides of said raised connecting section; each of said retaining elements defining an inner opening, and said two ribs being symmetrically arranged.

3. The connecting structure for T-square as claimed in claim 2, wherein said recessed fixing section includes two symmetric rails being provided at positions corresponding to said two ribs of said raised connecting section.

4. The connecting structure for T-square as claimed in claim 2, wherein said recessed fixing section includes two symmetric stops being provided at positions corresponding to said inner openings of said retaining elements of said raised connecting section.
